(19) United States
(12) Patent Application Publication
(10) Pub. No.: US 2023/0401954 A1
(43) Pub. Date: Dec. 14, 2023

(54) INFORMATION PROCESSING APPARATUS AND INFORMATION PROCESSING METHOD

(71) Applicant: TOYOTA JIDOSHA KABUSHIKI KAISHA, Toyota-shi Aichi-ken (JP)

(72) Inventors: Makoto TAMURA, Nagoya-shi Aichi-ken (JP); Aiko FUJII, Nagoya-shi Aichi-ken (JP)

(73) Assignee: TOYOTA JIDOSHA KABUSHIKI KAISHA, Toyota-shi Aichi-ken (JP)

(21) Appl. No.: 18/330,008

(22) Filed: Jun. 6, 2023

(30) Foreign Application Priority Data
Jun. 9, 2022 (JP) 2022-093416

(51) Int. Cl. G08G 1/01

(52) U.S. Cl. CPC G08G 1/0133; G08G 1/0112

(57) ABSTRACT

A controller is provided which is configured to determine, in response to obtaining first information about a possibility of an abnormality in a road, the abnormality in the road based on behaviors of a plurality of vehicles in a predetermined range including a position corresponding to the first information.

### CROSS REFERENCE TO THE RELATED APPLICATION

This application claims the benefit of Japanese Patent Application No. 2022-093416, filed on Jun. 9, 2022, which is hereby incorporated by reference herein in its entirety.

### BACKGROUND

### Technical Field

The present disclosure relates to an information processing apparatus and an information processing method.

### Description of the Related Art

There has been known a technique in which, when a vehicle encounters a road surface abnormality, it is determined based on the behavior of a vehicle whether or not an abnormality condition determined based on a specific behavior, which is assumed to be taken by the vehicle, is satisfied, and the state of a road surface is estimated according to the determination result (for example, see Patent Literature 1).

### CITATION LIST

### Patent Literature

Patent Literature 1: Japanese Patent Application Laid-Open Publication No. 2020-013537

### SUMMARY

The object of the present disclosure is to improve accuracy in the detection of an abnormality in a road.

One aspect of the present disclosure is directed to an information processing apparatus comprising a controller configured to determine, in response to obtaining first information about a possibility of an abnormality in a road, the abnormality in the road based on behaviors of a plurality of vehicles in a predetermined range including a position corresponding to the first information.

Another aspect of the present disclosure is directed to an information processing method comprising determining, by a computer, in response to obtaining first information about a possibility of an abnormality in a road, the abnormality in the road based on behaviors of a plurality of vehicles in a predetermined range including a position corresponding to the first information.

In addition, a further aspect of the present disclosure is directed to a program for causing a computer to perform the above-described method, or a storage medium storing the program in a non-transitory manner.

According to the present disclosure, it is possible to improve accuracy in the detection of an abnormality in a road.

### BRIEF DESCRIPTION OF THE DRAWINGS

FIG. 1 is a view illustrating a schematic configuration of a system according to an embodiment;

FIG. 2 is a block diagram schematically illustrating an example of a configuration of each of a vehicle, a user terminal and a server, which together constitute the system according to the embodiment;

FIG. 3 is a view illustrating an example of a travel trajectory of the vehicle;

FIG. 4 is a view of a road as viewed from above;

FIG. 5 is a view for explaining a calculation method of a lateral deviation;

FIG. 6 is a view illustrating changes over time in various data in an analysis range;

FIG. 7 is a view illustrating changes over time in various data in the analysis range;

FIG. 8 is a view illustrating changes over time in various data in the analysis range;

FIG. 9 is a view illustrating changes over time in various data in the analysis range;

FIG. 10 is a view illustrating changes over time in various data in the analysis range;

FIG. 11 is a view illustrating changes over time in various data in the analysis range;

FIG. 12 is a view illustrating travel trajectories when the same vehicle passed a plurality of times;

FIG. 13 is another view illustrating travel trajectories when the same vehicle passed a plurality of times;

FIG. 14 is a view illustrating data of the vehicles that stepped on a pothole before repair of the pothole;

FIG. 15 is a view illustrating data of the vehicles that did not step on the pothole before repair of the pothole;

FIG. 16 is a view illustrating data of the vehicles that stepped on the pothole after repair of the pothole;

FIG. 17 is a view illustrating data of the vehicles that did not step on the pothole after repair of the pothole;

FIG. 18 is a view summarizing the sample data illustrated in FIGS. 14 through 17;

FIG. 19 is a view illustrating a distribution of driving lanes;

FIG. 20 is a view illustrating an example of potholes present in a road;

FIG. 21 is a view of the road illustrated in FIG. 20 as viewed from above;

FIG. 22 illustrates data of the vehicles that stepped on the potholes before repair of the potholes in the example illustrated in FIGS. 20 and 21;

FIG. 23 illustrates data of the vehicles that did not step on the potholes before repair of the potholes in the example illustrated in FIGS. 20 and 21;

FIG. 24 is a view summarizing the sample data illustrated in FIGS. 22 through 23;

FIG. 25 illustrates data of vehicles on a rainy day and a sunny day in an analysis range of the road illustrated in FIG. 3;

FIG. 26 is a view illustrating the behaviors of the vehicles on a rainy day and a sunny day in the analysis range of the road illustrated in FIG. 3;

FIG. 27 is a diagram illustrating an example of a functional configuration of the server;

FIG. 28 is a view illustrating an example a table structure of vehicle information;

FIG. 29 is a diagram illustrating a functional configuration of a vehicle;

FIG. 30 is a flowchart for determining a possibility that a pothole is present according to a first embodiment;

FIG. 31 is a flowchart of processing for collecting data corresponding to a pothole candidate position;

FIG. 32 is a flowchart of processing for determining whether or not a pothole is present at the pothole candidate position;

FIG. 33 is a flowchart of processing for determining whether or not a pothole is present at the pothole candidate position;

FIG. 34 is a flowchart of processing for determining whether or not to monitor a road by the server;

FIG. 35 is a flowchart of processing for determining whether or not a pothole is present according to a fifth embodiment;

FIG. 36 is a flowchart of processing for determining whether or not a pothole is present, based on driving lanes according to the fifth embodiment; and

FIG. 37 is a flowchart of processing for notifying the presence of a pothole based on data of a plurality of vehicles.

### DESCRIPTION OF THE EMBODIMENTS

An information processing apparatus, which is one aspect of the present disclosure, includes a controller. The controller is configured to determine, in response to obtaining first information about a possibility of an abnormality in a road, the abnormality in the road based on behaviors of a plurality of vehicles in a predetermined range including a position corresponding to the first information.

Examples of abnormality in the road include breakage of the road, peeling of asphalt or concrete of a road surface, dent or depression in the road surface, unevenness of the road surface, cracks in the road surface, etc. First information about the possibility of an abnormality in the road may be information corresponding to an abnormality in the road transmitted from a vehicle or information corresponding to reception of a report indicating that there is an abnormality in the road from an occupant of the vehicle who has passed through the road or a pedestrian or other person who has passed through the road. For example, when a vehicle passes through a place where there is an abnormality in a road, for example, vibration may occur in the vehicle or a rotational speed of a wheel may change according to the abnormality in the road. In cases where such information is obtained from the vehicle, there is a high possibility that an abnormality is occurring in the road. When obtaining the information about the possibility that there is an abnormality in the road, the controller determines whether or not there is actually an abnormality.

A position corresponding to the first information is, for example, a position at which an abnormality is occurring, a position at which an abnormality in the road has been reported, or a position at which information corresponding to an abnormality in the road has been transmitted from a vehicle. The predetermined range is, for example, a range in which the abnormality in the road affects the behavior of the vehicle. For example, the predetermined range is a range in which at least part of the behavior of the vehicle appears when the driver of the vehicle finds and avoids the abnormality in the road. For example, the predetermined range may be a range in which the direction of travel of the vehicle changes to the left or right, or a range in which the vehicle passes through a position corresponding to the abnormality in the road.

When there is an abnormality in the road, the driver of the vehicle may take evasive action. On the other hand, when the driver of the vehicle does not notice the abnormality in the road, the vehicle may pass through a place where there is the abnormality in the road, so that, for example, vibration may occur in the vehicle or the rotational speed of a wheel may change according to the abnormality in the road. Since the occurrence of the vibration, the change in the rotational speed of the wheel, and the like do not appear in the vehicle that has passed while avoiding the position where the abnormality is present in the road, there is a concern about erroneous determination if the abnormality in the road is determined based on the occurrence of the vibration, the change in the rotational speed of the wheel, and the like.

As described above, in cases where there is an abnormality in the road, there are vehicles that take evasive action and others that pass through the location or position of the abnormality without taking evasive action, so there is a difference in the behaviors of the respective vehicles. Therefore, it is possible to determine whether or not there is an abnormality in the road based on the difference in the behaviors.

Here, if an attempt is made to determine road abnormalities based on the behaviors of a plurality of vehicles for all parts or locations of all roads, the computation involved becomes enormous and takes time. On the other hand, it is possible to reduce the computational load by determining whether or not there is an abnormality in a road, in response to the acquisition of first information about the possibility that there is an abnormality in the road.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

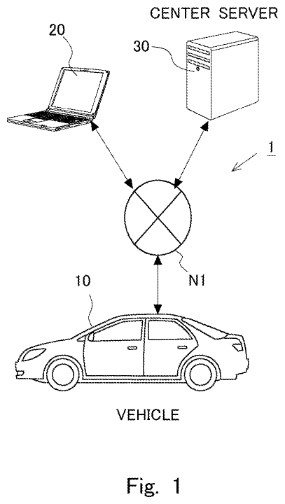

FIG. 1 is a view illustrating a schematic configuration of a system 1 according to a first embodiment. In the example of FIG. 1, the system 1 includes a vehicle 10, a user terminal 20 and a server 30. The system 1 is a system in which the server 30 obtains information about road abnormalities from a plurality of vehicles 10 and determines road abnormalities based on the information. Although the system 1 illustrated in FIG. 1 includes one vehicle 10 as an example, there may be a plurality of vehicles 10.

The vehicle 10, the user terminal 20 and the server 30 are connected to one another by means of a network N1. The network N1 is, for example, a worldwide public communication network such as the Internet or the like, and a WAN (Wide Area Network) or other communication networks may be adopted. Also, the network N1 may include a telephone communication network such as a mobile phone network or the like, or a wireless communication network such as Wi-Fi (registered trademark) or the like.

The user terminal 20 obtains information about abnormalities on roads from the server 30. The user terminal 20 is, for example, a device used by a user who manages the roads. For example, the server 30 transmits the location or position at which it is determined that there is a road abnormality to the user terminal 20. The user who has obtained the information from the user terminal 20 performs road repairs or the like.

The vehicle 10 is a connected car, and transmits various data during travel to the server 30 via the network N1. The vehicle 10 detects, for example, a steering angle, a rotational speed of each wheel, an acceleration in a vertical direction (which may be vibration), and a current position or location, and transmits the information thus detected to the server 30.

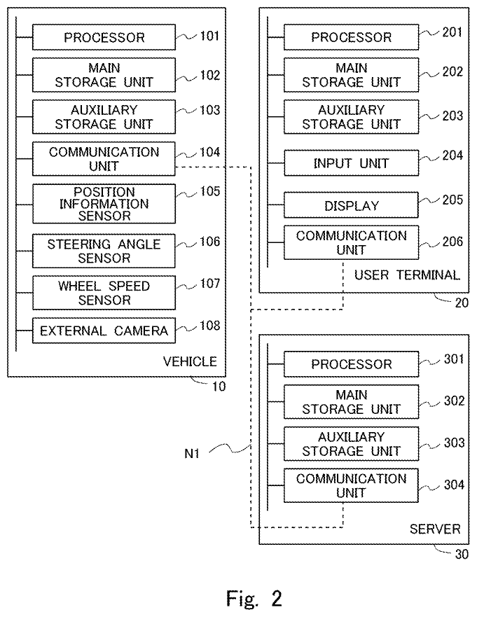

Hardware configurations and functional configurations of the vehicle the user terminal 20 and the server 30 will be described based on FIG. 2. FIG. 2 is a block diagram schematically illustrating an example of a configuration of each of the vehicle 10, the user terminal 20 and the server which together constitute the system 1 according to the present embodiment.

The server 30 has a configuration of a computer. The server 30 includes a processor 301, a main storage unit 302, an auxiliary storage unit 303, and a communication unit 304. These components are connected to one another by means of a bus.

The processor 301 is a CPU (Central Processing Unit), a DSP (Digital Signal Processor), or the like. The processor 301 controls the server 30 thereby to perform various information processing operations. The main storage unit 302 is a RAM (Random Access Memory), a ROM (Read Only Memory), or the like. The auxiliary storage unit 303 is an EPROM (Erasable Programmable ROM), a hard disk drive (HDD), a removable medium, or the like. The auxiliary storage unit 303 stores an operating system (OS), various programs, various tables, and the like. The processor 301 loads a program stored in the auxiliary storage unit 303 into a work area of the main storage unit 302 and executes the program, so that each component or the like is controlled through the execution of the program. As a result, the server 30 realizes functions that match predetermined purposes. The main storage unit 302 and the auxiliary storage unit 303 are computer readable recording media. Here, note that the server 30 may be a single computer or a plurality of computers that cooperate with one another. In addition, the information stored in the auxiliary storage unit 303 may be stored in the main storage unit 302. Also, the information stored in the main storage unit 302 may be stored in the auxiliary storage unit 303. Note that the processor 301 is an example of a controller.

The communication unit 304 is a means or unit that communicates with the vehicle 10 and the user terminal 20 via the network N1. The communication unit 304 is, for example, a LAN (Local Area Network) interface board, a wireless communication circuit for wireless communication, or the like. The LAN interface board or the wireless communication circuit is connected to the network N1.

Here, note that a series of processing executed by the server 30 can be executed by hardware, but can also be executed by software.

Now, the user terminal 20 will be described. The user terminal 20 is, for example, a personal computer (PC), a smart phone, a mobile phone, a tablet terminal, a personal information terminal, or a small computer such as a wearable computer (such as a smart watch or the like). The user terminal 20 includes a processor 201, a main storage unit 202, an auxiliary storage unit 203, an input unit 204, a display 205, and a communication unit 206. These components are connected to one another by means of a bus. The processor 201, the main storage unit 202 and the auxiliary storage unit 203 are the same as the processor 301, the main storage unit 302 and the auxiliary storage unit 303 of the server 30, respectively, and hence, the description thereof will be omitted.

The input unit 204 is a means or unit that receives an input operation performed by the user, and is, for example, a touch panel, a mouse, a keyboard, a push button, or the like. The display 205 is a means or unit that presents information to the user, and is, for example, an LCD (Liquid Crystal Display), an EL (Electroluminescence) panel, or the like. The input unit 204 and the display 205 may be configured as a single touch panel display.

The communication unit 206 is a communication means for connecting the user terminal 20 to the network N1. The communication unit 206 is, for example, a circuit for communicating with other devices (e.g., the server 30 and the like) via the network N1 by making use of a mobile communication service (e.g., a telephone communication network such as (5th Generation), 4G (4th Generation), 3G (3rd Generation), LTE (Long Term Evolution) or the like), and/or a wireless communication network such as Wi-Fi (registered trademark), Bluetooth (registered trademark) or the like.

Now, the vehicle 10 will be described. The vehicle 10 includes a processor 101, a main storage unit 102, an auxiliary storage unit 103, a communication unit 104, a position information sensor 105, a steering angle sensor 106, a wheel speed sensor 107, and an external camera 108. These components are connected to one another by means of a bus. The processor 101, the main storage unit 102, the auxiliary storage unit 103, and the communication unit 104 are the same as the processor 201, the main storage unit 202, the auxiliary storage unit 203, and the communication unit 206 of the user terminal 20, respectively, and hence, the description thereof will be omitted.

The position information sensor 105 obtains position information (e.g., latitude and longitude) of the vehicle 10 at a predetermined cycle. The position information sensor 105 is, for example, a GPS (Global Positioning System) receiver unit, a wireless communication unit or the like. The information obtained by the position information sensor 105 is recorded, for example, in the auxiliary storage unit 103 or the like and transmitted to the server 30.

The steering angle sensor 106 is a sensor that detects a steering angle obtained by a steering operation. The steering angle sensor 106 detects, for example, an angle of a steering wheel. Here, note that the angle of the steering wheel is detected as the steering angle in the present embodiment, but a value directly or indirectly representing a turning angle of a tire may be used. The wheel speed sensor 107 is a sensor that detects a rotational speed of a wheel.

The external camera 108 is a camera that is installed toward the outside of the vehicle 10, and is a camera that captures images in front of the vehicle 10. The external camera 108 is a camera that captures images by using an imaging device such as a CCD (Charge Coupled Device) image sensor, a CMOS (Complementary Metal Oxide Semiconductor) image sensor or the like. The images captured by the external camera 108 may be either still images or moving images.

Here, when the vehicle 10 steps on a dent or depression (a pothole: hereinafter, referred to as a “PH”) formed in the road, it is detected by the wheel speed sensor 107. For example, a wheel acceleration can be calculated based on a temporal change in the wheel speed obtained by the wheel speed sensor 107. The wheel acceleration increases when the PH is stepped on, and hence, it can be considered that the PH is stepped on when the wheel acceleration increases by a predetermined value or more. However, the driver of the vehicle 10 may remember the position of the PH when passing through the same place a plurality of times. When the driver remembers the position of the PH, the vehicle 10 may be operated so as not to step on the PH. Then, it is difficult to detect the PH by means of the wheel speed sensor 107. In this way, when the number of vehicles 10 avoiding the PH increases, it may be difficult to determine whether the PH is actually present. Therefore, the behavior of a vehicle 10 when the driver knows the position of the PH or avoids the PH before the vehicle 10 steps on the PH was investigated, and whether it is possible to determine the presence or absence of the PH based on the behavior of the vehicle 10 was examined, as a result of which it was found that the presence or absence of the PH can be determined based on the behavior of the vehicle 10.

First, in a place where the PH was occurring, the behavior of the vehicle 10 before and after the position of the PH was analyzed. In addition, in order to observe changes in the behavior of the vehicle 10 depending on the presence or absence of the PH, comparison was made between data before and after the repair of the PH at the same location.

In the analysis, the time when the vehicle 10 traveled in the vicinity of the PH was identified, and data was extracted for 2 seconds each before and after the vehicle 10 passed through the PH. When the vehicle 10 is traveling at a speed of, for example, 30 to 50 km per hour, it is assumed that the distance at which the PH can be recognized is around 30 m. For example, when the vehicle is traveling at around 50 km per hour, the distance is from about 30 m before PH to about 30 m after PH. A range of m before and after this PH is hereinafter also referred to as an analysis range.

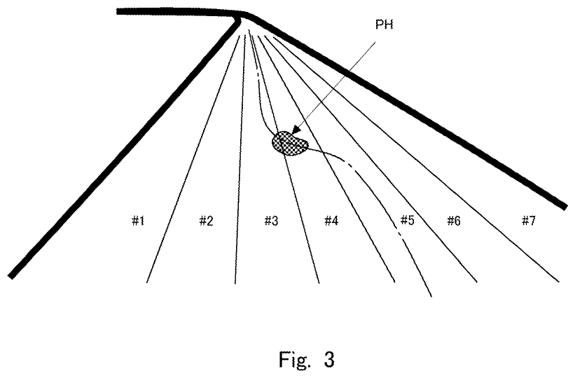

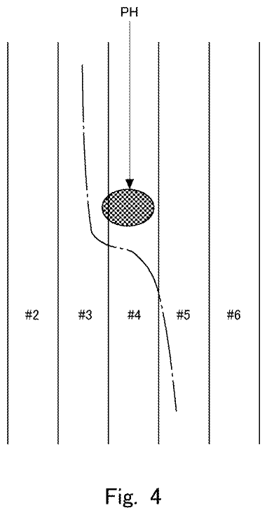

For each of vehicles 10, the locations or positions traveled were calculated based on the position information obtained by the position information sensor 105, and the travel trajectories of the vehicles 10 were obtained by arranging these positions in chronological order. Based on these travel trajectories, the travel pattern and lateral deviation (shift) of each vehicle 10 were analyzed. At this time, the road was divided into a plurality of lanes, and the travel trajectory of each vehicle 10 was analyzed. FIG. 3 is a view illustrating an example of a travel trajectory of a vehicle 10. The road was divided into seven equal parts, and an analysis was performed on the assumption that there were seven lanes from a first lane (#1) to a seventh lane (#7). FIG. 4 is a view of the road as seen from above. Here, lanes other than the first lane (#1) and the seventh lane (#7) were analyzed as an analysis range, because the first lane (#1) and the seventh lane (#7) at both ends of the road are rarely traveled by the vehicle 10 under normal circumstances. In FIGS. 3 and 4, an alternate long and short dashed line represents the travel trajectory of the vehicle 10. A PH is present across a third lane (#3) and a fourth lane (#4).

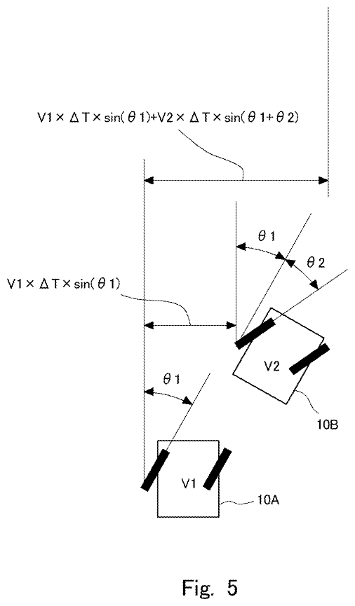

In addition, the lateral deviation is a moving distance in a lateral (transverse) direction of the vehicle 10, and was calculated as follows. FIG. 5 is a view for explaining a calculation method for the lateral deviation. In FIG. 5, reference sign 10A indicates the vehicle 10 at a first position, and reference sign 10B indicates the vehicle 10 at a second position. Also, θ1 represents a steering angle of the vehicle 10A at the first position, and θ2 represents a steering angle of the vehicle 10B at the second position, which is a steering angle changed from θ1. The distance that the vehicle 10 moves laterally from the first position to the second position (i.e., an amount of lateral deviation) can be expressed in Equation 1 below.

Amount of lateral deviation=V1×ΔT×sin(θ1) (Equation 1),

where V1 is the speed of the vehicle 10A at the first position in the direction of travel (the direction in which the wheels are facing), and ΔT is the time required for the vehicle 10 to move from the first position to the second position.

Also, an amount of lateral deviation from the second position to a third position, which is a position after further ΔT seconds, can be expressed by the following Equation 2.

Amount of lateral deviation=V1×ΔT×sin(θ1)+V2×ΔT×sin(θ1+θ2) (Equation 2),

where V2 is the speed of the vehicle 10B at the second position in the direction of travel, and ΔT is the same value as ΔT in (Equation 1).

A relatively large travel trajectory of the vehicle 10 was analyzed based on the travel pattern obtained from the position information, and a relatively small behavior of the vehicle 10 was analyzed based on the lateral deviation obtained from the steering angle.

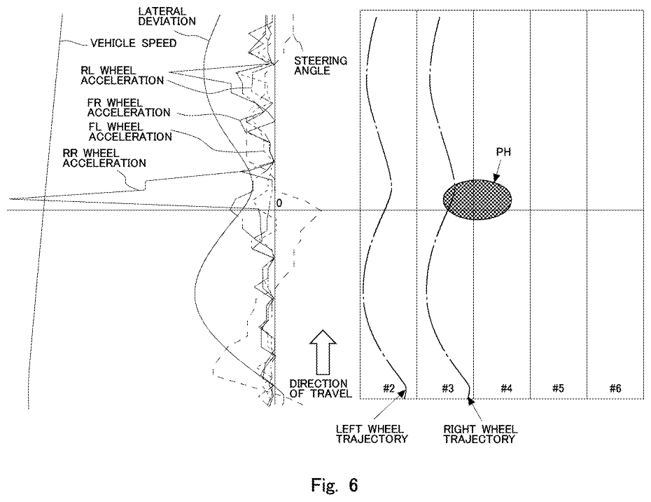

FIGS. 6 through 11 are views illustrating changes over time in various data in the analysis range. These are data detected by the sensor of the vehicle 10 from 2 seconds before the vehicle 10 passes through the position where the PH is present to 2 seconds after the vehicle 10 passes through the position where the PH is present. The vehicle 10 is moving in the direction indicated by a “DIRECTION OF TRAVEL” arrow, and the data corresponding to each point in time are plotted. “VEHICLE SPEED” indicates the speed of the vehicle 10, and “LATERAL DEVIATION” indicates the amount of lateral deviation described with reference to FIG. 5. “STEERING ANGLE” indicates the angle of the steering wheel, and indicates the direction and angle of rotation thereof when the steering wheel is rotated to the right side or the left side with 0 as a boundary. “FR WHEEL ACCELERATION”, “FL WHEEL ACCELERATION”, “RR WHEEL ACCELERATION”, and “RL WHEEL ACCELERATION” indicate the rotational accelerations of the front right, front left, rear right, and rear left wheels, respectively. These rotational accelerations become larger when the PH is stepped on.

In FIG. 6, “#2” to “#6” correspond to the lanes described with reference to FIG. 4. “RIGHT WHEEL TRAJECTORY” corresponds to the trajectory of the right front or right rear wheel, and “LEFT WHEEL TRAJECTORY” corresponds to the trajectory of the left front or left rear wheel. The trajectories of the wheels are estimated based on the position information of the vehicle 10.

In the example illustrated in FIG. 6, the vehicle 10 steps on the PH with the right front and right rear wheels. When the vehicle 10 enters the analysis range, the steering wheel is turned to the right after being turned to the left. In the vicinity of the PH, the steering wheel is turned to the left again, and then turned to the right. The vehicle 10 is traveling while reducing its speed in the analysis range. The acceleration of the right rear wheel (RR wheel acceleration) is large in the vicinity of the PH, and it can be seen that the wheel is stepping on the PH.

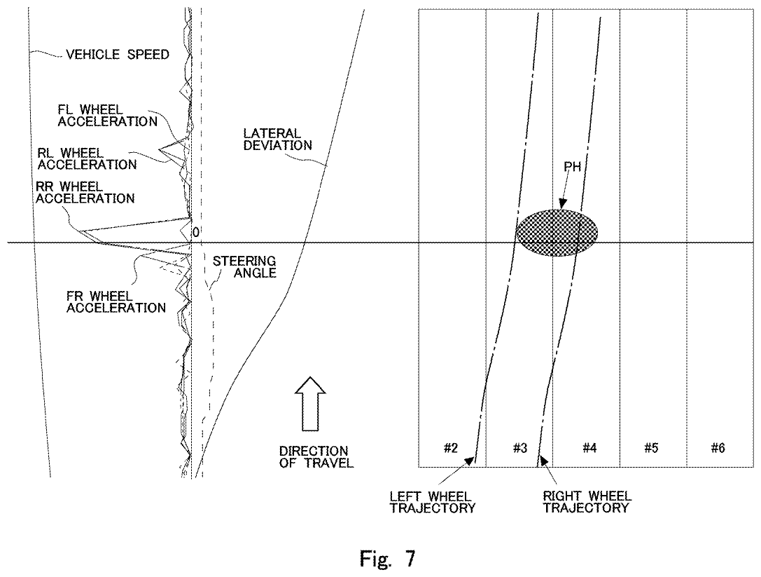

In the example illustrated in FIG. 7, the vehicle 10 steps on the PH with the right front and right rear wheels. The vehicle 10 is moving while accelerating and deviating (shifting) to the right in the analysis range. The acceleration of the right front wheel (FR wheel acceleration) and the acceleration of the right rear wheel (RR wheel acceleration) are large in the vicinity of the PH, and it can be seen that the vehicle is stepping on the PH.

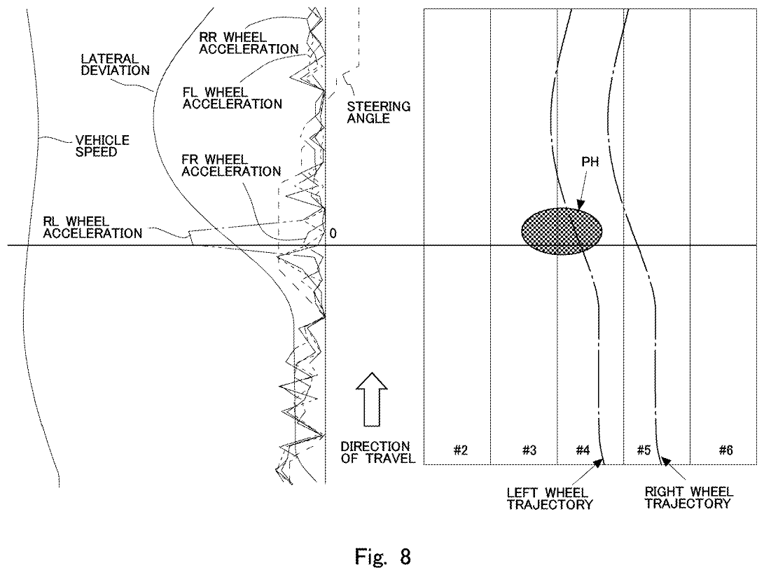

In the example illustrated in FIG. 8, the vehicle 10 is stepping on the PH with the left rear wheel. After the vehicle 10 enters the analysis range and goes straight ahead, the steering wheel is turned to the left before the PH, and then it is turned to the right after passing the PH. In addition, the vehicle 10 is traveling while increasing its speed. The acceleration of the left rear wheel (RL wheel acceleration) is large in the vicinity of the PH, and it can be seen that the left rear wheel is stepping on the PH.

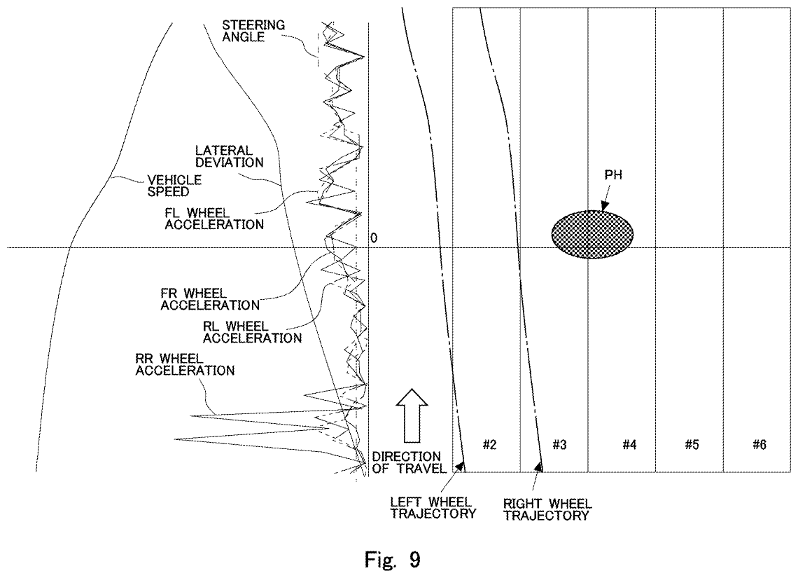

In the example illustrated in FIG. 9, the vehicle 10 avoids the PH by moving to the left side. In the vehicle 10, the steering wheel is turned to the left while decelerating its speed in the analysis range. Thus, the vehicle 10 passes through the PH without stepping on the PH.

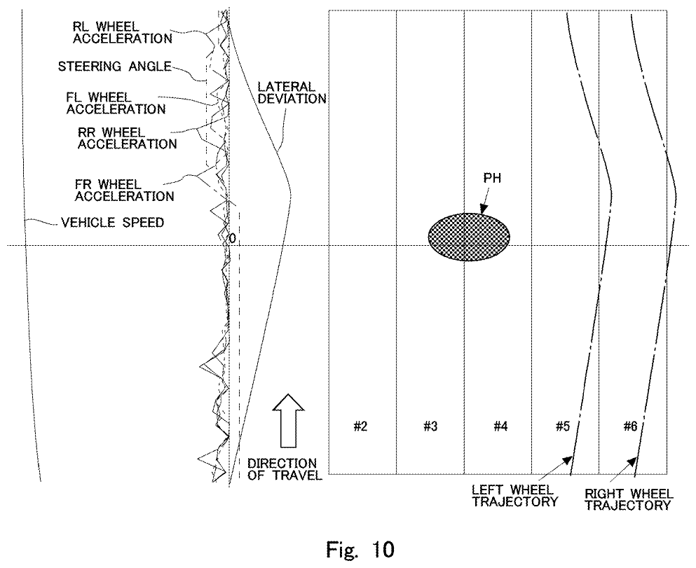

In the example illustrated in FIG. 10, the vehicle 10 avoids the PH by moving to the right side. The vehicle 10 is steered to the right while traveling at a relatively high speed in the analysis range, and is steered to the left after avoiding the PH. Thus, the vehicle 10 passes through the PH without stepping on the PH.

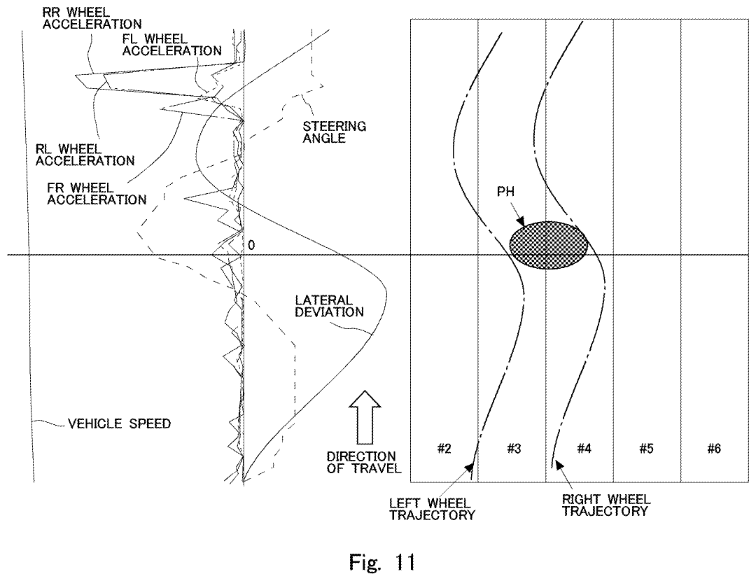

In the example illustrated in FIG. 11, the vehicle 10 runs so that the right wheels are positioned on the right side of the PH and the left wheels are positioned on the left side of the PH, thereby avoiding the PH. The vehicle speed is substantially unchanged. At this time, the vehicle 10 passes over the PH, but the wheels thereof do not step on the PH. Thus, it is considered that the driver has driven the vehicle 10 to straddle the PH, while looking at the PH.

As illustrated in FIGS. 6 through 11, there are the following three patterns for avoiding the PH.
(1) The vehicle is driven to travel on the left side of the road from the beginning, and further the steering wheel is turned to the left.
(2) The vehicle is driven to travel on the right side of the road from the beginning and further the steering wheel is turned to the right.
(3) The steering wheel is operated so that the vehicle travels in an S shape while traveling in the center of the road.

The S-shaped travel includes a case where the steering wheel is operated in the order of left, right, and left, and a case where the steering wheel is operated in the order of right, left, and right.

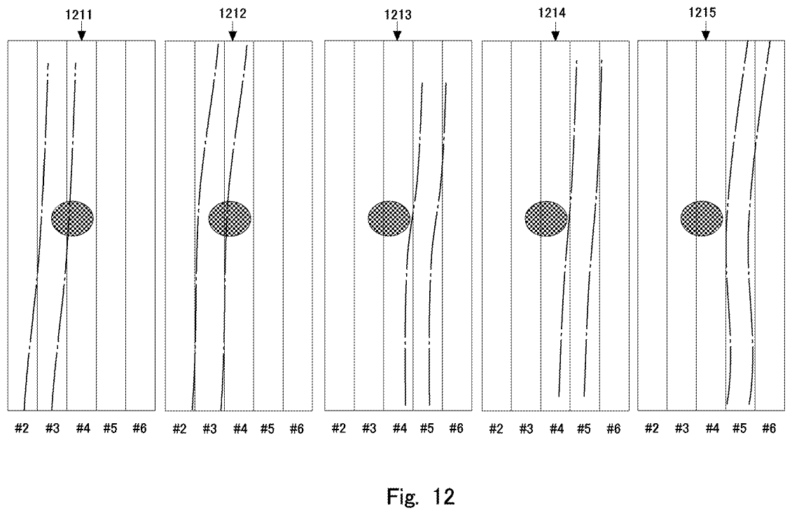

On the other hand, the vehicle 10, which is stepping on the PH, shows less behavior to avoid the PH as described above, and tends to go straight. The vehicle 10, which has traveled through the same place a plurality of times, tends to behave in such a way that it steps on the PH the first time but does not step on the PH when passing through the same place thereafter. FIG. 12 is a view illustrating travel trajectories when the same vehicle 10 has passed through the same place a plurality of times. The vehicle 10 has passed through the same analysis range five times from 1211 to 1215. Reference numeral 1211 denotes a travel trajectory when the vehicle 10 passed through the analysis range for the first time. In the first time 1211, the vehicle 10 was not able to avoid the PH and stepped on the PH with the right wheel. Reference numeral 1212 denotes a travel trajectory when the vehicle 10 passed through the analysis range for the second time. Even in the second time 1212, the vehicle 10 was not able to avoid the PH and stepped on the PH with the right wheel.

On the other hand, in any of the third and subsequent times 1213 through 1215, the vehicle 10 avoids the PH by deviating or shifting to the right in the analysis range. In this way, when passing through the same place a plurality of times, the driver remembers the position of the PH, so takes a route that avoids or evades the PH. At this time, if the driver is traveling the evasive route from further ahead of the analysis range, it is possible that the steering angle changes little in the analysis range. In this case, it is difficult to determine whether the driver knows the presence of the PH and is taking that route, or whether the driver is taking that route without knowing the presence of the PH.

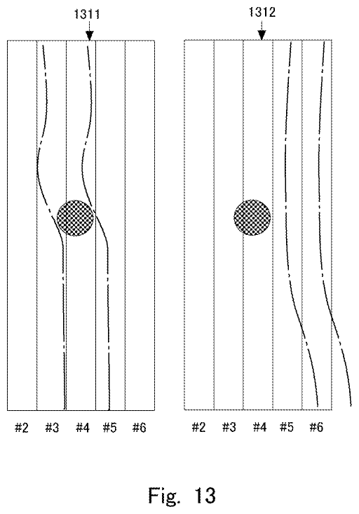

FIG. 13 is another view illustrating travel trajectories when the same vehicle 10 has passed a plurality of times. The vehicle 10 passed through the same analysis range twice, 1311 and 1312. Reference numeral 1311 denotes a travel trajectory when the vehicle 10 passed through the analysis range for the first time. Reference numeral 1312 denotes a travel trajectory when the same vehicle 10 passed through the same analysis range thereafter. In the first time 1311, the vehicle 10 is steered relatively sharply in an attempt to pass the PH between the left and right wheels so as to avoid the PH. On the other hand, in the second time 1312, the vehicle travels on the right side of the road to avoid the PH before entering the analysis range. In this way, looking only at the data of 1312, there is no sudden change in the direction of travel and the PH is not stepped on, so there is no output corresponding to the PH in the detected value of the wheel speed sensor 107.

Here, the following hypotheses were made.
(1) The vehicles 10 that do not step on the PH have a higher tendency to travel in an S shape than the vehicles 10 that step on the PH. That is, the vehicles travel in an S shape so as to avoid the PH, which requires a larger amount of steering operation than on a road without the PH.
(2) There is a difference in the driving lanes before and after the repair of the PH, and relatively many vehicles 10 travel on the left side of the road after the PH repair.

These hypotheses are verified below.

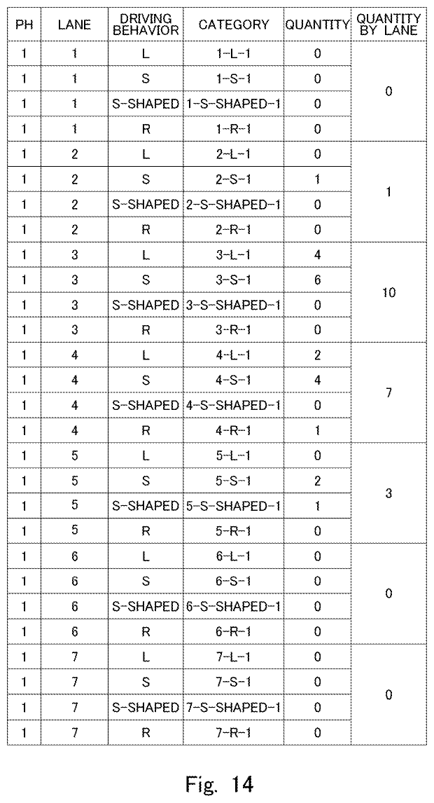

FIGS. 14 through 17 are views illustrating sample data. FIG. 14 illustrates data for the vehicles 10 that stepped on the PH before the repair of the PH. In FIG. 14, “PH” indicates whether or not the PH was stepped on, with “1” displayed if the PH was stepped on and “0” if it was not. “LANE” indicates the driving lane at the time when the vehicle 10 enters the analysis range. “DRIVING BEHAVIOR” indicates the behavior observed in the vehicle 10 in the analysis range. In the “DRIVING BEHAVIOR”, “L” indicates that the vehicle 10 traveled while being deviated to the left side, “S” indicates that the vehicle 10 traveled straight, “S-SHAPED” indicates that the vehicle 10 traveled in an S shaped curve, and “R” indicates that the vehicle 10 traveled while being deviated to the right side. “CATEGORY” indicates the lane traveled, driving behavior, and whether or not the PH was stepped on. A first number in the “CATEGORY” corresponds to a “lane”. A second character in the “CATEGORY” corresponds to “driving behavior”. A third number in the “CATEGORY” correspond to the “PH”. For example, a row in which “2-L-1” is described in the CATEGORY is a row describing a vehicle 10 that entered the analysis range from the second lane, traveled while being deviated to the left side, and stepped on the PH. Also, in FIG. 14, “QUANTITY” indicates the number of vehicles 10, and “QUANTITY BY LANE” indicates the number of vehicles 10 corresponding to each lane.

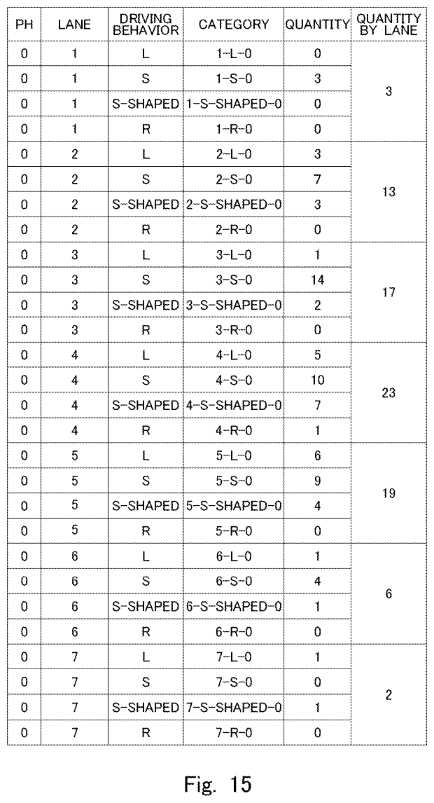

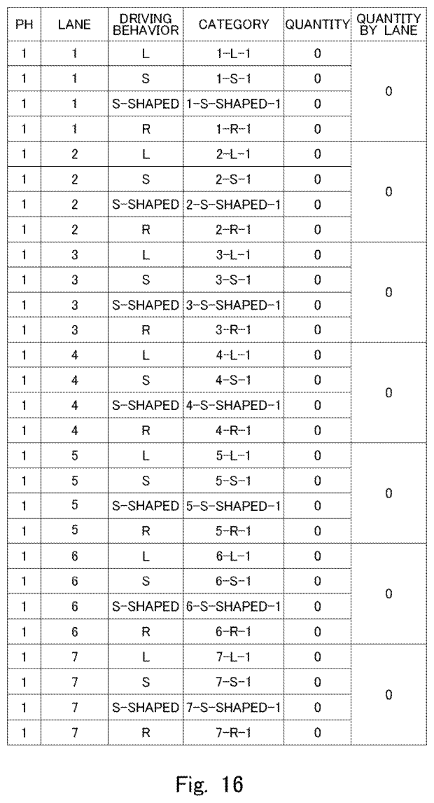

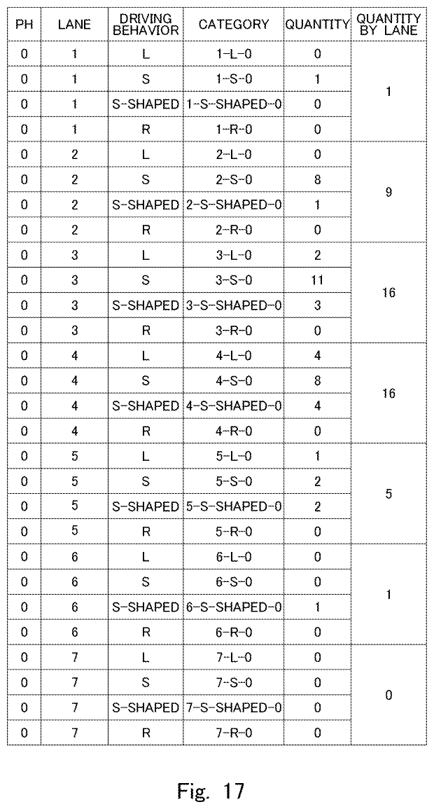

In addition, FIG. 15 illustrates data for the vehicles 10 that did not step on the PH before the repair of the PH. In this case, a third number (PH) in the “CATEGORY” is indicated by “0”. FIG. 16 illustrates data for the vehicles 10 that stepped on the PH after the repair of the PH. In this case, a third number (PH) in the “CATEGORY” is indicated by “1”. FIG. 17 illustrates data for the vehicles 10 that did not step on the PH after the repair of the PH. In this case, a third number (PH) in the “CATEGORY” is indicated by “0”. After the repair of the PH, there is no PH, and hence all vehicles 10 are categorized as the vehicles 10 that did not step on the PH.

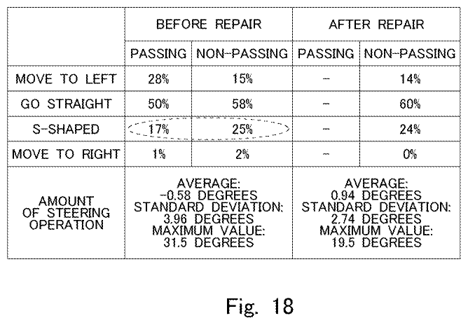

FIG. 18 is a view summarizing the sample data illustrated in FIGS. 14 through 17. In FIG. 18, “MOVE TO LEFT” indicates the vehicles 10 whose “Driving Behavior” is “L” in FIGS. 14 through 17. “GO STRAIGHT” indicates the vehicles 10 whose “DRIVING BEHAVIOR” is “S” in FIGS. 14 through 17. “S-SHAPED” indicates the vehicles 10 whose “DRIVING BEHAVIOR” is “S-SHAPED” in FIGS. 14 through 17. “MOVE TO RIGHT” indicates the vehicles 10 whose “DRIVING BEHAVIOR” is “R” in FIGS. 14 through 17. “AMOUNT OF STEERING OPERATION” indicates information about a maximum angle when the steering wheel is operated.

Further, “BEFORE REPAIR” corresponds to sample data before the repair of the PH, and “AFTER REPAIR” corresponds to sample data after the repair of the PH. “PASSING” indicates the vehicles 10 that stepped on the PH, and “NON-PASSING” indicates the vehicles 10 that did not step on the PH. FIG. 18 summarizes the analysis by focusing on the vehicles 10 whose lanes are the second through fourth lanes when they enter the analysis range.

In the “BEFORE REPAIR”, there are many “S-SHAPED” vehicles 10 in both the “PASSING” and “NON-PASSING”. That is, it can be seen that there were many vehicles 10 that tried to avoid the PH by performing S-shaped driving, among both the vehicles 10 that stepped on the PH and the vehicles 10 that did not step on the PH. In addition, when the “AMOUNT OF STEERING OPERATION” in the “BEFORE PH REPAIR” and that in the “AFTER PH REPAIR” are compared with each other, it can be understood that the standard deviation and the maximum value of the “AMOUNT OF STEERING OPERATION” are larger in the “BEFORE REPAIR”, and thus the operation amount of the steering wheel is larger. Also, when the “PASSING” and “NON-PASSING” in the “BEFORE REPAIR” are compared with each other with respect to the vehicles 10 in the “S-SHAPED”, it is found that the ratio of the “NON-PASSING” is high. Therefore, it can be understood that the above-described hypothesis “(1) The vehicles 10 that do not step on the PH have a higher tendency to travel in an S shape than the vehicles 10 that step on the PH.” is correct.

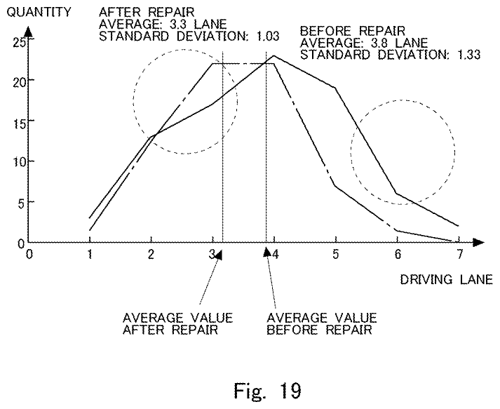

In addition, FIG. 19 is a view illustrating a distribution of driving lanes. A solid line indicates a population before the PH repair, and a long and short dashed line indicates a population after the PH repair. Note that a t-test was conducted to confirm that the two populations, before and after the PH repair, were different and differed as groups. Looking at the respective driving lanes, the population before the PH repair has an average of 3.8 lane and a standard deviation of 1.33, while the population after the PH repair has an average of 3.3 lane and a standard deviation of 1.03. It can be seen that the driving lanes shift to the left after the PH repair compared to before the PH repair. Therefore, before the PH repair, the vehicle is considered to be traveling while being deviated to the right side as a PH avoidance behavior. Therefore, it can be understood that the above-described hypothesis “(2) There is a difference in the driving lanes before and after the repair of the PH, and relatively many vehicles 10 travel on the left side of the road after the PH repair.” is correct.

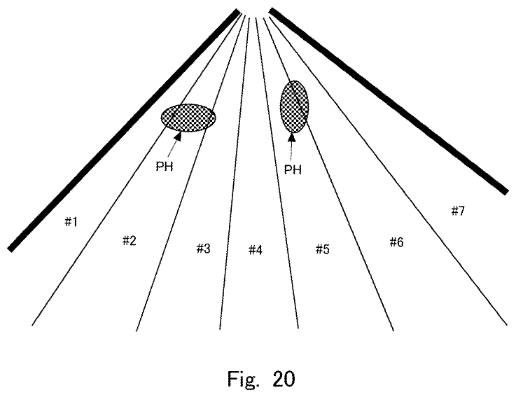

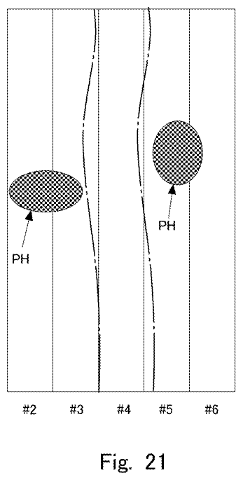

FIG. 20 is a view illustrating an example of PHs present in a road. Similar to the example illustrated in FIG. 3, it is assumed that the road is divided into seven equal parts, so there are seven lanes, i.e., a first lane (#1) through a seventh lane (#7). In the example illustrated in FIG. 20, there are two PHs. In addition, FIG. 21 is a view of the road illustrated in FIG. 20 as viewed from above. As in FIG. 4, lanes other than the first lane (#1) and the seventh lane (#7) were analyzed as an analysis range. In FIG. 21, alternate long and short dashed lines represent the travel trajectory of a vehicle 10. One of the PHs is located across a second lane (#2) and a third lane (#3), and the other PH is located across a fifth lane (#5) and a sixth lane (#6).

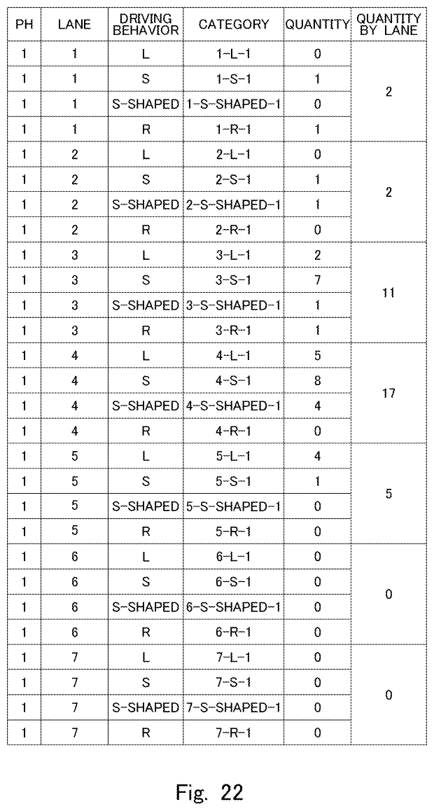

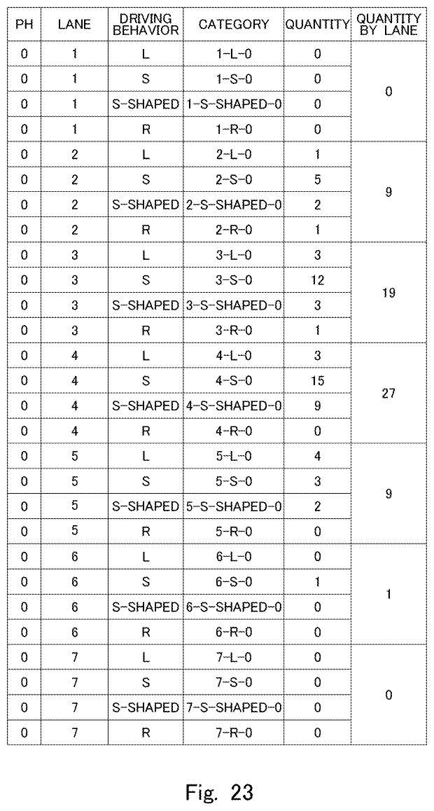

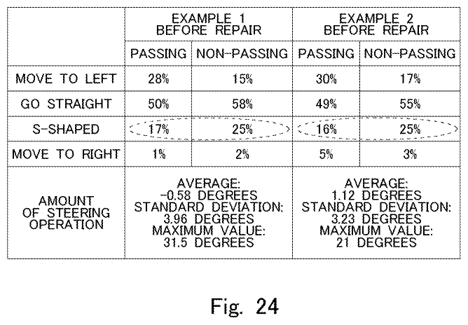

FIG. 22 illustrates data of the vehicles that stepped on the PHs before the repair of the PHs in the example illustrated in FIGS. 20 and 21. Also, FIG. 23 illustrates data of the vehicles that did not step on the PHs before the repair of the PHs in the example illustrated in FIGS. 20 and 21. The structure of the data is the same as that illustrated in FIGS. 14 and 15. FIG. 24 is a view summarizing the sample data illustrated in FIGS. 22 and 23. In FIG. 24, “EXAMPLE 1 BEFORE REPAIR” represents the data before repair illustrated in FIG. 18, and “EXAMPLE 2 BEFORE REPAIR” represents the data corresponding to FIGS. 22 and 23. In the “EXAMPLE 2 BEFORE REPAIR” in FIG. 24, too, the tendency of the vehicles 10 that performed an S-shaped travel is the same as that in the “EXAMPLE 1 BEFORE REPAIR”. That is, when comparing “PASSING” and “NON-PASSING” in the “EXAMPLE 2 BEFORE REPAIR”, it can be seen that the “NON-PASSING” has a higher tendency to perform an S-shaped travel.

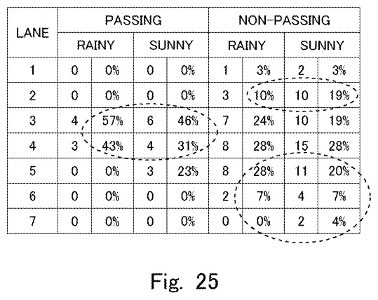

In addition, the behaviors of the vehicles 10 may change depending on the weather, so the analysis was performed based on data obtained on different weather days. FIG. 25 illustrates data of the vehicles 10 on a rainy day and a sunny day in the analysis range of the road illustrated in FIG. 3. “RAINY” indicates data collected on the rainy day, and “SUNNY DAY” indicates data collected on the sunny day. The vehicles 10 that stepped on the PH (i.e., those categorized as “PASSING”) are more likely to travel in the vicinity of the center of the road, i.e., in the third lane and the fourth lane, on both rainy and sunny days. On the other hand, the vehicles 10 that did not step on the PH (i.e., those categorized as “NON-PASSING”) are more likely to travel on both sides of the road, i.e., in the second lane and the fifth through seventh lanes, on both rainy and sunny days.

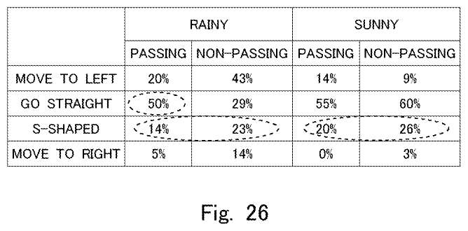

FIG. 26 is a view illustrating the behaviors of the vehicles on a rainy day and a sunny day in the analysis range of the road illustrated in FIG. 3. The vehicles 10 that stepped on the PH tend to go straight on the rainy day and the sunny day. As illustrated in FIG. 25, the vehicles 10 that stepped on the PH have a high tendency to go straight in the vicinity of the center of the road. Even on the rainy day and the sunny day, there are also the vehicles 10 that perform an S-shaped travel. Then, regardless of whether it is the rainy day or the sunny day, the “NON-PASSING” vehicles 10 have a higher rate of performing an S-shaped travel than the “PASSING” vehicles 10.

As described above, it can be seen that in the place where a PH is present, the number of vehicles 10 exhibiting the behavior of avoiding the PH increases, and the number of vehicles 10 changing their travel routes to avoid the PH increases. Therefore, based on the amount of operation of the steering wheel or the amount of lateral deviation of each vehicle 10 during 2 seconds before and after the place where a PH is thought to be present, it is possible to determine whether or not the PH is present at that place. In addition, based on the entry route of each vehicle 10 into the analysis range, it is also possible to determine whether or not the PH is present at the place. Note that the meaning of “the place where a PH is thought to be present” referred to herein is, for example, a place where the detected values of the wheel speed sensors 107 in a plurality of vehicles 10 indicate the presence of a PH. Even in such a place, since the PH cannot be detected from the wheel speed sensors 107 of the vehicles 10 that avoided the PH, it is not immediately determined whether the PH is actually present, but rather whether the PH is present or not is determined based on the behaviors of the vehicles 10.

Therefore, the server 30 extracts a place where the PH is thought to occur, based on the data obtained from the vehicles 10. Then, an analysis range is set for the extracted place, and it is determined whether or not a PH is actually occurring, based on the presence or absence of an S-shaped travel in the analysis range. Note that the S-shaped travel is an example of a first behavior.

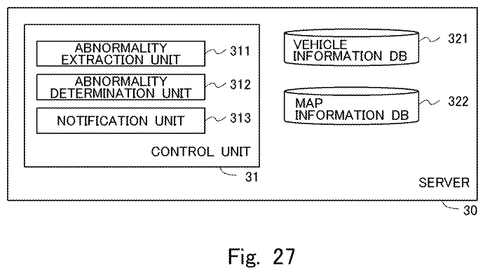

FIG. 27 is a diagram illustrating an example of a functional configuration of the server 30. The server 30 includes, as its functional components, a control unit 31, a vehicle information DB 321, and a map information DB 322. The processor 301 of the server 30 executes the processing of the control unit 31 by means of a computer program on the main storage unit 302. However, any of the individual functional components or a part of the processing thereof may be implemented by a hardware circuit. The control unit 31 includes an abnormality extraction unit 311, an abnormality determination unit 312, and a notification unit 313.

The vehicle information DB 321 and the map information DB 322 are, for example, relational databases that are created by a program of a database management system (DBMS) that is executed by the processor 301 to manage data stored in the auxiliary storage unit 303. Here, note that any of the individual functional components of the server 30 or a part of the processing thereof may be executed by another computer or other computers connected to the network N1.

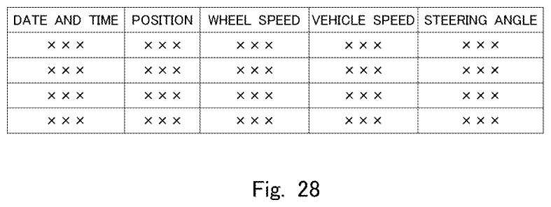

The vehicle information DB 321 is formed by storing information on date and time, position, wheel speed, vehicle speed, and steering angle in the auxiliary storage unit 303. Here, the configuration or structure of the vehicle information stored in the vehicle information DB 321 will be described based on FIG. 28. FIG. 28 is a view illustrating an example a table structure of the vehicle information. A vehicle information table is formed for each vehicle 10. The vehicle information table has fields of date and time, position, wheel speed, vehicle speed, and steering angle. In the date and time field, information about the date and time when data was obtained in each vehicle 10 is entered. In the position field, information about the position detected by each position information sensor 105 is entered. The position is represented by, for example, coordinates. In the wheel speed field, information about the wheel speed detected by each wheel speed sensor 107 is entered. In the vehicle speed field, information about the speed of each vehicle 10 is entered. The speed of each vehicle may be calculated based on the detected value of the corresponding wheel speed sensor 107 and the outer diameter of the tires of the vehicle registered in advance, or the detected value of a speed sensor attached to each vehicle 10 may be obtained. In the steering angle field, information about the steering angle detected by each steering angle sensor 106 is entered. These pieces of information are transmitted from each vehicle 10 at predetermined time intervals.

In the map information DB 322, map information including map data and POI (Point of Interest) information such as texts and/or photographs that show the characteristics of each point on the map data is stored. Note that the map information DB 322 may be provided from other systems connected to the network N1 such as, for example, a GIS (Geographic Information System).

The abnormality extraction unit 311 extracts a position at which the PH is likely to be present, based on the data stored in the vehicle information DB 321. Here, for example, for each vehicle 10, the position information, the detected value of the wheel speed sensor 107, and the date and time thereof are stored in the vehicle information DB 321 in association with each other. Based on these pieces of information, the abnormality extraction unit 311 extracts a position at which the PH may be present. The abnormality extraction unit 311 calculates the rotational acceleration of each wheel based on the detected value of each wheel speed sensor 107. Then, a position at which the rotational acceleration of a wheel is equal to or greater than a predetermined acceleration is extracted. Then, for example, in a predetermined number or more of vehicles 10, a position at which the rotational accelerations of wheels are equal to or greater than the predetermined acceleration is extracted as a position at which the PH may be present.

In the present embodiment, the abnormality extraction unit 311 extracts the position at which the PH is likely to be present based on the detected value of each wheel speed sensor 107, but the present disclosure is not limited thereto, and the position at which the PH is likely to be present may be extracted based on the detected values of other sensors that each output a signal corresponding to the PH. In addition, for example, a position at which the driver of a vehicle 10 or a pedestrian on a road reports that there is a PH may be extracted as a position at which a PH may be present. In this case, information about the reported position is transmitted from the user terminal 20 to the server 30. Further, by analyzing the images captured by the external camera 108, a position at which a PH is likely to be present may be extracted.

The abnormality determination unit 312 determines whether or not the PH is actually present at the position (hereinafter, also referred to as a PH candidate position) at which the PH is likely to be present and which is extracted by the abnormality extraction unit 311. The abnormality determination unit 312 sets an analysis range for the PH candidate position. The analysis range is set to, for example, a range in which the vehicle 10 travels for 2 seconds before and after the PH candidate position based on the speed of the vehicle 10. In addition, the abnormality determination unit 312 divides the analysis range into, for example, seven lanes. Note that in the present embodiment, an analysis is performed by dividing the road into the seven lanes, but the number of divisions is not limited thereto. For example, the number of divisions may be increased according to the width of the road. Further, the number of divisions may be determined according to an average speed of the vehicle 10.

The abnormality determination unit 312 obtains from the vehicle information DB 321 an entry lane of the vehicle 10 that passed through the analysis range. Further, the abnormality determination unit 312 determines whether or not the vehicle 10 that passed through the analysis range performed an S-shaped travel. The abnormality determination unit 312 may, for example, determine that the vehicle 10 performed an S-shaped travel when there was a predetermined amount of lateral deviation or displacement (e.g., 30 cm) to the left and right. Note that, instead of the amount of lateral deviation, when the standard deviation of the amount of operation of the steering wheel is equal to or greater than a predetermined value, or when the maximum value of the amount of operation of the steering wheel is equal to or greater than a predetermined value, or when the variance of the amount of operation of the steering wheel is equal to or greater than a predetermined value, it may be determined that an S-shaped travel was performed. As described with reference to FIG. 18, when the PH is present, the standard deviation of the amount of operation of the steering wheel and the maximum value of the amount of operation of the steering wheel increase, and thus it is also possible to make the determination based on these values.

Then, the abnormality determination unit 312 determines based on the detected values of the wheel speed sensors 107 at the PH candidate position whether the PH is actually present or not by comparing the vehicles 10 for which the detected values corresponding to when they stepped on the PH were obtained with the vehicles 10 for which the detected values corresponding to when they stepped on the PH were not obtained. Specifically, the abnormality determination unit 312 determines that the PH is present, when the proportion of vehicles 10 that performed an S-shaped travel among the vehicles 10 that did not step on the PH is greater than the proportion of vehicles 10 that performed an S-shaped travel among the vehicles 10 that stepped on the PH. That is, when there is a tendency of numerical values enclosed by a dashed line in FIG. 18, it is determined that the PH is present.

Then, when the abnormality determination unit 312 determines that the PH is present, the notification unit 313 outputs to the user terminal 20 information indicating that the PH is occurring. This information includes information (e.g., latitude and longitude) about the location where the PH is occurring. Note that the position at which the PH is occurring may be identified based on the data stored in the map information DB 322.

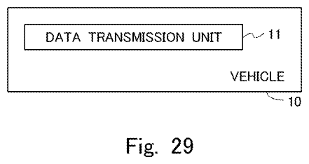

Now, the functions of the vehicle 10 will be described. FIG. 29 is a view illustrating a functional configuration of the vehicle 10. The vehicle 10 has a data transmission unit 11 as a functional component. The processor 101 of the vehicle 10 executes the processing of the data transmission unit 11 by means of a computer program on the main storage unit 102. However, any of the individual functional components or a part of the processing thereof may be implemented by a hardware circuit.

The data transmission unit 11 acquires the data obtained by the position information sensor 105, the steering angle sensor 106, the wheel speed sensor 107, and the external camera 108 at predetermined time intervals and transmits the data to the server 30.

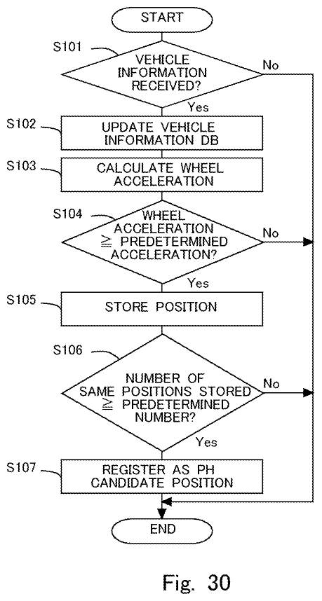

Next, PH determination processing in the server 30 will be described. When receiving data from the vehicle 10, the server 30 makes a determination as to the possible presence of a PH. FIG. 30 is a flowchart for determining a possibility that a PH is present according to the first embodiment. The processing illustrated in FIG. 30 is executed at predetermined time intervals at the server 30.

In step S101, the abnormality extraction unit 311 determines whether or not vehicle information has been received from the vehicle 10. The vehicle information is information stored in the vehicle information DB 321. When an affirmative determination is made in step S101, the processing or routine proceeds to step S102, whereas when a negative determination is made, this routine is ended. In step S102, the abnormality extraction unit 311 stores and/or updates the vehicle information in the vehicle information DB 321. Then in step S103, the abnormality extraction unit 311 calculates a wheel acceleration. For example, the wheel acceleration is calculated based on the wheel speed of the previous routine, the wheel speed of the current routine, and the interval between the routines. At this time, the wheel acceleration for each of the four wheels is calculated.

In step S104, the abnormality extraction unit 311 determines whether or not the wheel acceleration is equal to or greater than a predetermined acceleration. The predetermined acceleration referred to herein is a lower limit value of the wheel acceleration in the case of stepping on a PH. In this step S104, even if the wheel acceleration of only one of the four wheels is equal to or greater than the predetermined acceleration, an affirmative determination is made. When an affirmative determination is made in step S104, the processing or routine proceeds to step S106, whereas when a negative determination is made, this routine is ended.

In step S105, the abnormality extraction unit 311 stores the position of the vehicle 10. In step S106, when the same positions have been stored, the abnormality extraction unit 311 determines whether or not the number of the same positions stored is equal to or greater than a predetermined number. The predetermined number referred to herein is set as a value at which a PH is likely to be present. That is, when there are a predetermined number or more of vehicles 10 whose wheel accelerations are equal to or greater than the predetermined acceleration at the same position, it is highly likely that a PH is present at that position. When an affirmative determination is made in step S106, the processing or routine proceeds to step S107, whereas when a negative determination is made, this routine is ended. In step S107, the abnormality extraction unit 311 registers the position stored in step S105 as a PH candidate position. In this way, the abnormality extraction unit 311 extracts the PH candidate position.

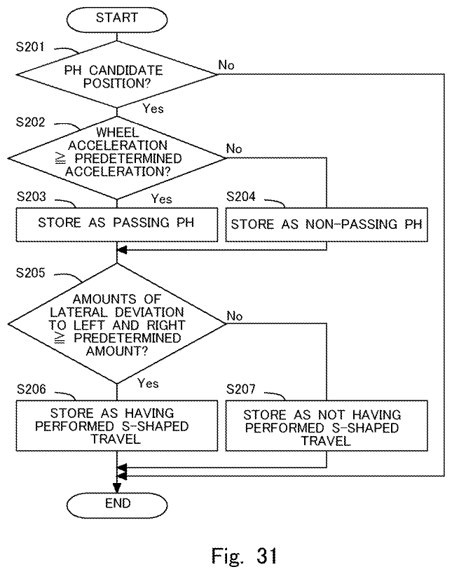

Next, processing of collecting data at the position registered as the PH candidate position will be described. FIG. 31 is a flowchart of the processing for collecting data corresponding to a PH candidate position. The processing illustrated in FIG. 31 is executed in the server 30 after the routine illustrated in FIG. 30.

In step S201, the abnormality determination unit 312 determines whether or not the position of the vehicle 10 is the PH candidate position. The registered PH candidate position and the position transmitted from the vehicle 10 are compared by the abnormality determination unit 312. When an affirmative determination is made in step S201, the processing or routine proceeds to step S202, whereas when a negative determination is made, this routine is ended. In step S202, the abnormality determination unit 312 determines whether or not the wheel acceleration is equal to or greater than the predetermined acceleration. Processing similar to that in step S104 is executed. When an affirmative determination is made in step S202, the processing proceeds to step S203, whereas when a negative determination is made, the processing proceeds to step S204.

In step S203, the abnormality determination unit 312 stores, in the auxiliary storage unit 303, information indicating that the vehicle 10 has passed the PH (i.e., has stepped on the PH). On the other hand, in step S204, the abnormality determination unit 312 stores, in the auxiliary storage unit 303, information indicating that the vehicle 10 has not passed through the PH (i.e., has not stepped on the PH).

In step S205, the abnormality determination unit 312 determines whether or not an amount of lateral (left or right) deviation of the vehicle 10 is greater than or equal to the predetermined amount. In this step S205, it is determined whether or not the vehicle 10 has performed an S-shaped travel. The amounts of lateral deviation to the left and right are distances deviated or shifted to the left side and the right side, respectively. The predetermined amount referred to herein is an amount of deviation in the case where an S-shaped travel for avoiding the PH was performed, and is, for example, 30 cm. That is, when the direction of travel changes in the order of right, left, and right, with a shift of, for example, 30 cm to the right side and then, a shift of, for example, 30 cm to the left side, it is determined that the amounts of lateral deviation to the left and right sides are equal to or greater than the predetermined amount. Similarly, in the case where the direction of travel changes in order of left, right, and left, when a shift of, for example, 30 cm is performed to the left side and then, a shift of, for example, 30 cm is performed to the right side, it is determined that the amounts of lateral deviation to the left and right sides are equal to or greater than the predetermined amount. When an affirmative determination is made in step S205, the processing proceeds to step S206, whereas when a negative determination is made, the processing proceeds to step S207.

In step S206, the abnormality determination unit 312 stores, in the auxiliary storage unit 303, information indicating that the vehicle 10 has performed an S-shaped travel. On the other hand, in step S207, the abnormality determination unit 312 stores, in the auxiliary storage unit 303, information indicating that the vehicle 10 has not performed an S-shaped travel. In this way, information about the wheel acceleration and the amount of lateral deviation is accumulated for the vehicle 10 passing in the vicinity of the PH candidate position.

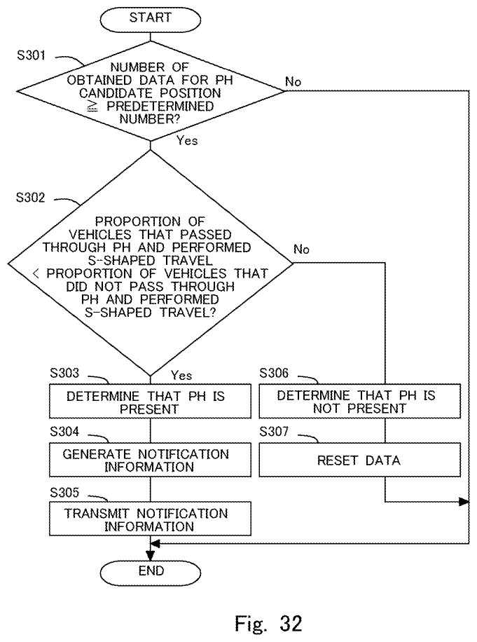

Next, processing of determining whether or not a PH is present at the PH candidate position will be described. FIG. 32 is a flowchart of processing for determining whether or not a PH is present at the PH candidate position. The processing illustrated in FIG. 32 is executed at predetermined time intervals at the server 30.

In step S301, the abnormality determination unit 312 determines whether or not the number of obtained data corresponding to the PH candidate position is equal to or greater than a predetermined number. That is, it is determined whether or not the number of vehicles 10 that have passed through the PH candidate position has reached a number sufficient to determine the presence of the PH. The predetermined number referred to herein is a number used when determining the presence of the PH, and is stored in the auxiliary storage unit 303 in advance. The larger the predetermined number, the higher the accuracy of determination can be made, but since it takes more time to collect data, the predetermined number should be determined based on how much priority is given to either the accuracy of determination or the time required to collect data. When an affirmative determination is made in step S301, the processing or routine proceeds to step S302, whereas when a negative determination is made, this routine is ended.

In step S302, the abnormality determination unit 312 determines whether or not a PH is present. That is, the proportion of vehicles 10 that were stored as having passed the PH in step S203 and that were stored as having performed an S-shaped travel in step S206 (hereinafter referred to as “S-shaped-1” vehicles) is compared with the proportion of vehicles 10 that were stored as having not passed the PH in step S204 and that were stored as having performed an S-shaped travel in step S206 (hereinafter referred to as “S-shaped-0” vehicles).

The “S-shaped-1” vehicles are considered to be the vehicles 10 whose drivers noticed the PH and took evasive action, but stepped on the PH. On the other hand, the “S-shaped-0” vehicles are considered to be the vehicles 10 whose drivers noticed the PH, took evasive action, and did not step on the PH. As can be seen by looking at an area enclosed by the dashed line in FIG. 18, the proportion of the “S-shaped-0” vehicles among the vehicles 10 that did not pass through the PH is higher than the proportion of the “S-shaped-1” vehicles among the vehicles 10 that passed through the PH. Thus, even among the vehicles 10 that performed an S-shaped travel, there is a clear difference between the vehicles 10 that stepped on the PH and the vehicles 10 that did not step on the PH.

Therefore, when such a tendency is observed in the PH candidate position, it is determined that a PH is present. In step S302, the abnormality determination unit 312 determines whether or not the proportion of the “S-shaped-0” vehicles among the vehicles 10 that have not passed through the PH is higher than the proportion of the “S-shaped-1” vehicles among the vehicles 10 that have passed through the PH. When an affirmative determination is made in step S302, the processing proceeds to step S303, whereas when a negative determination is made, the processing proceeds to step S306.

In step S303, the abnormality determination unit 312 determines that a PH is present at the PH candidate position. In response to the determination by the abnormality determination unit 312 that a PH is present at the PH candidate position, in step S304, the notification unit 313 generates notification information, which is information for notifying the user terminal 20 of the occurrence of the PH. This notification information includes information about the position where the PH is occurring. Then, in step S305, the notification unit 313 transmits the notification information to the user terminal 20. In the user terminal 20 that has received the notification information, for example, the position of the PH is displayed on the display 205. At this time, for example, the position of the PH may be indicated on a map that is displayed on the display 205.

On the other hand, in step S306, the abnormality determination unit 312 determines that there is no PH at the PH candidate position. In this case, the user terminal 20 may be notified that the PH is determined not to be present. In step S307, the abnormality determination unit 312 resets the data regarding the corresponding PH candidate position.

As described above, according to the first embodiment, the PH candidate position is identified based on the detected values of the wheel speed sensors 107 obtained from the vehicles 10. However, if only the detected values of the wheel speed sensors 107 are used, for example, the same detected values can be obtained when stepping on a manhole cover as when stepping on a PH, so there is a concern of erroneous determination. On the other hand, the abnormality determination unit 312 determines whether or not a PH is present based on whether or not an S-shaped travel is further performed at the PH candidate position. Among the vehicles 10 that performed an S-shaped travel, there is a clear difference in proportion between the vehicles 10 that stepped on the PH and the vehicles 10 that did not step on the PH, which shows a different tendency than when, for example, a manhole cover was stepped on. Since it is determined whether or not a PH is present based on this tendency, it is possible to determine whether or not a PH is present with higher accuracy than when determining whether or not a PH is present based simply on whether or not the vehicles have performed an S-shaped travel or based simply on the detected values of the wheel speed sensors 107.

### Second Embodiment

In a second embodiment, the presence or absence of a PH is determined based on the lanes traveled by vehicles 10. Other configurations are the same as in the first embodiment, and thus the description thereof will be omitted. The abnormality determination unit 312 of the server 30 compares the past data with the current data, and determines that a PH is present in a place where there is a change in the lanes in which each vehicle 10 is traveling (hereinafter, the driving lanes). Therefore, the abnormality extraction unit 311 stores the data obtained from the vehicles 10 in the auxiliary storage unit 303. Then, for example, when a PH candidate position is extracted, the past data and the current data at the PH candidate position are compared with each other. For example, as illustrated in FIG. 19, the driving lanes of the vehicles 10 change depending on the presence or absence of a PH. Thus, for example, an average value of the driving lanes in a past predetermined period (first period) and an average value of the driving lanes in a future predetermined period (second period) from the present time are respectively calculated, and if a difference or ratio between them is greater than or equal to a predetermined value, it is determined that a PH is present.

Here, note that the driving lanes may be obtained using the detected values of the position information sensors 105, or may be obtained by analyzing the images obtained by the external camera 108. In addition, although the road illustrated in FIG. 19 is divided into seven lanes, the number of divisions may be changed according to the width of the road.

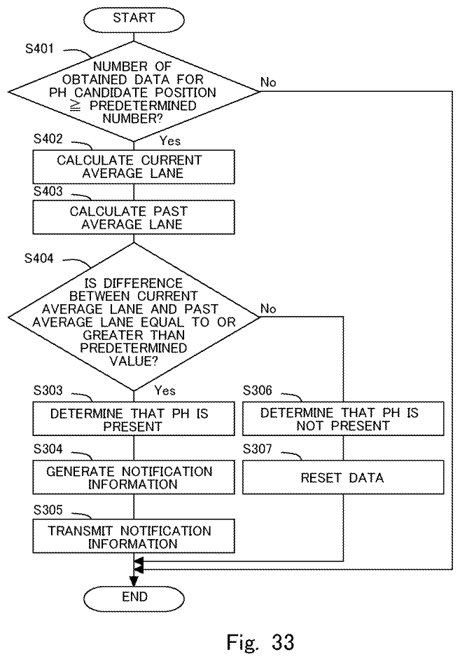

The abnormality extraction unit 311 extracts a PH candidate position by the processing illustrated in FIG. 30. FIG. 33 is a flowchart of processing for determining whether or not a PH is present at the PH candidate position. The processing illustrated in FIG. 33 is executed at predetermined time intervals at the server 30. Here, note that those steps in which the same processing is performed as in the routine illustrated in FIG. 32 are denoted by the same reference signs, and the description thereof will be omitted.

In step S401, the abnormality determination unit 312 determines whether or not the number of obtained data corresponding to the PH candidate position is equal to or greater than a predetermined number. This number of obtained data is the number of data at the same position newly obtained after the PH candidate position is extracted. The predetermined number referred to herein is the number of data with which the average value of lanes traveled by the vehicles 10 can be calculated with high accuracy, and is stored in the auxiliary storage unit 303 in advance. The larger the predetermined number, the higher the accuracy of determination can be made, but since it takes more time to collect data, the predetermined number is determined based on how much priority is given to either the accuracy of determination or the time required to collect data. When an affirmative determination is made in step S401, the processing or routine proceeds to step S402, whereas when a negative determination is made, this routine is ended.

In step S402, the abnormality determination unit 312 calculates the average value of the driving lanes of each vehicle 10 at the present time at the PH candidate position. The abnormality determination unit 312 sets an analysis range based on the PH candidate position, extracts the driving lane at the time of entering the analysis range for each vehicle 10, and calculates the average value of the driving lanes. This average value is calculated, for example, for a predetermined number of vehicles 10 that have passed through the analysis range most recently.

In step S403, the abnormality determination unit 312 calculates the average value of the driving lanes of each vehicle 10 in the past at the PH candidate position. Here, the term “in the past” represents a time before the PH candidate position is extracted. The abnormality determination unit 312 extracts, from the vehicle information stored in the vehicle information DB 321, records in which dates and times are included in a past predetermined period and positions are included in the analysis range, and obtains the driving lanes based on respective pieces of the position information. For example, the road is divided into seven lanes, and the range of the position of each lane is obtained by the abnormality determination unit 312 and stored in the auxiliary storage unit 303. Then, it is determined in which range of each lane stored in the auxiliary storage unit 303 the position information stored in the vehicle information DB 321 is included. The abnormality determination unit 312, for example, calculates the average lane by extracting data for the same number of vehicles 10 as the predetermined number related to step S401.

In step S404, the abnormality determination unit 312 determines whether or not a difference between the average value of the current driving lanes calculated in step S402 and the average value of the past driving lanes calculated in step S403 is equal to or greater than a predetermined value. The predetermined value is stored in the auxiliary storage unit 303 as a difference between the lanes when the PH is present and when it is not. When an affirmative determination is made in step S404, the processing proceeds to step S303, whereas when a negative determination is made, the processing proceeds to step S306.

As described above, according to the second embodiment, it is possible to determine whether or not a PH is present by comparing the current and past driving lanes obtained from the vehicles 10.

Here, note that in second embodiment, the current average lane and the past average lane at the same place are compared with each other, but the past average lane used for comparison may be an average lane at a different place. For example, the average lane at the time when the vehicles 10 travel on roads all over the country may be determined in advance and used as a comparison target.

### Third Embodiment

In the first embodiment, it is determined whether or not an S-shaped travel is performed using the current vehicle information, and then, based on the results of that determination, it is determined whether or not a PH is present, but instead of this, it may be determined that a PH is present, in cases where the number of vehicles 10 performing an S-shaped travel is increasing based on a comparison with the past data. In a third embodiment, for example, vehicle data at times when it is known that a PH is not occurring has been stored in the auxiliary storage unit 303. Then, it may be determined that a PH is present, in cases where a difference or a ratio between the proportion of the vehicles 10 that performed an S-shaped travel in the past at the PH candidate position and the proportion of the vehicles 10 that are currently performing an S-shaped travel is equal to or greater than a predetermined difference or a predetermined ratio.

The abnormality determination unit 312 of the server 30 calculates the proportion of the vehicles 10 that performed an S-shaped travel among all the vehicles 10 that passed through the analysis range in the past predetermined period. In addition, the abnormality determination unit 312 calculates the proportion of the vehicles 10 that performed an S-shaped travel among all the vehicles 10 that passed through the analysis range in the predetermined period from the present time. Then, the proportion of vehicles 10 that performed an S-shaped travel is compared between the past and the present, and when a difference between them is equal to or greater than a predetermined difference, it is determined that a PH is present. The predetermined difference referred to herein is the proportion of the vehicles 10 performing an S-shaped travel that increases due to the occurrence of the PH, and is stored in the auxiliary storage unit 303.

Thus, by comparing the proportion of the vehicles 10 that performed an S-shaped travel between the present and the past, it is also possible to determine whether or not a PH is present.

### Fourth Embodiment

In a fourth embodiment, the presence or absence of a PH is determined in combination with human inspection of a road. Here, a person may visually inspect a road. For example, in the monitoring by the server an abnormality of a road may be overlooked. In addition, when the amount of the vehicle 10 passing through the PH candidate position is small, it takes time to determine the presence of PH. Therefore, it is also conceivable that a person goes to the site and visually checks the presence of a PH. On the other hand, it takes a lot of people and time to check all roads only by visual observation. Therefore, in the fourth embodiment, a road is monitored by combining visual observation by a person and monitoring by the server 30.

The server 30 should obtain a schedule of human visual inspections of a road, and for a predetermined period of time after a visual inspection, the server 30 will not determine the presence of a PH at the same place. That is, in cases where a visual inspection is performed, there is no PH, or even if there is a PH, the PH will be repaired, and thus the presence of a PH is not determined for a predetermined period of time after the visual inspection. Then, after a predetermined period of time has elapsed since the visual inspection, the presence or absence of a PH is determined. For example, the processing in FIG. 30 in the first through third embodiments may not be performed for a predetermined period of time after the visual inspection is performed. Thus, the load on the server 30 can be reduced. In addition, after the predetermined period of time has elapsed since the visual inspection, a new PH may occur, so monitoring by the server 30 is performed. That is, the processing in FIG. 30 is executed at predetermined time intervals. In this way, when a PH occurs, it can be determined that a PH is present without having to wait for the next visual inspection, thus allowing the PH to be repaired as soon as possible.

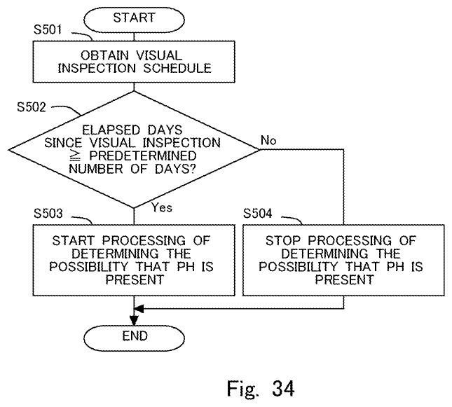

FIG. 34 is a flowchart of processing for determining whether or not to monitor the road by the server 30. A routine illustrated in FIG. 34 is executed at predetermined time intervals at the server 30. In addition, this routine is executed, for example, for each road, for each area, or for each predetermined range. In step S501, the abnormality extraction unit 311 obtains a schedule of visual inspections of each road. The visual inspection schedule of each road is input, for example, in the user terminal 20 and stored in the auxiliary storage unit 303 of the server 30. This schedule includes information about the dates and times and the positions at which the visual inspection is performed.

In step S502, the abnormality extraction unit 311 determines whether or not the number of days elapsed since the visual inspection is equal to or greater than a predetermined number of days. The predetermined number of days is stored in the auxiliary storage unit 303 as the number of days in which a PH can occur. When an affirmative determination is made in step S502, the processing proceeds to step S503, whereas when a negative determination is made, the processing proceeds to step S504.

In step S503, the abnormality extraction unit 311 starts processing of determining the possibility of the presence of a PH. This processing is the processing illustrated in FIG. 30. On the other hand, in step S504, the abnormality determination unit 312 stops the processing of determining the possibility of the presence of a PH.

As described above, according to the fourth embodiment, it is possible to reduce the computational load of the server 30 because the presence of a PH is determined by a combination of the visual inspection by a person and the monitoring of roads by the server 30. In addition, while the visual inspection alone may take time to detect a suddenly occurring PH, the combination of monitoring by the server 30 enables early detection of the PH.

### Fifth Embodiment

In a fifth embodiment, the past behavior and the present behavior of the same vehicle 10 are compared with each other to determine whether or not a PH is present. As explained in FIG. 12, when the same vehicle 10 passes a place where a PH is present a plurality of times, the vehicle 10 may step on the PH in the beginning, but as the driver learns the position of the PH, the vehicle 10 will not step on the PH anymore. Therefore, for example, if it is determined that a PH may have been stepped on based on the detected value of the wheel speed sensor 107, but if it is not determined thereafter that a PH may have been stepped on based on the detected value of the wheel speed sensor 107, a PH is considered to be present there. For example, a PH may be determined to be present when the PH is no longer detected by the wheel speed sensor 107 and when the vehicle 10 has performed an S-shaped travel. In addition, a PH may be determined to be present when the PH is no longer detected by the wheel speed sensor 107 and when the lane in which the vehicle 10 is traveling has changed.

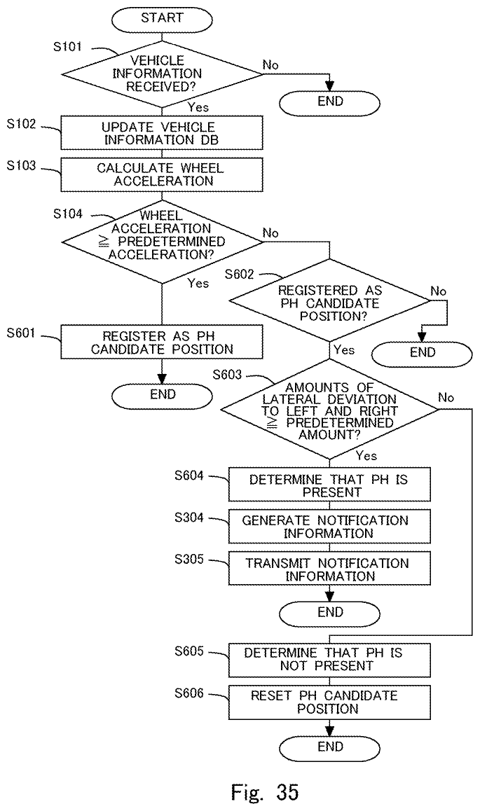

FIG. 35 is a flowchart of processing for determining whether or not a PH is present according to the fifth embodiment. A routine illustrated in FIG. 35 is executed at predetermined time intervals at the server 30. Here, note that the steps in which the same processing is performed as in the flowcharts described above are denoted by the same reference signs, and the description thereof will be omitted. In the routine illustrated in FIG. 35, when an affirmative determination is made in step S104, the processing proceeds to step S601. In step S601, the abnormality extraction unit 311 registers the position of the vehicle 10 as a PH candidate position. Here, if the wheel acceleration is equal to or greater than a predetermined acceleration, that position is immediately registered as a PH candidate position. This PH candidate position is a position corresponding only to the vehicle 10 concerned, and even if other vehicles 10 pass through this position, it is not treated as a PH candidate position.

On the other hand, when a negative determination is made in step S104, the processing proceeds to step S602. In step S602, the abnormality determination unit 312 determines whether or not the position of the vehicle 10 is the position registered as a PH candidate position. In other words, it is determined whether or not the information corresponding to when the PH is stepped on has already been output from the vehicle 10. When an affirmative determination is made in step S602, the processing or routine proceeds to step S603, whereas when a negative determination is made, this routine is ended.

In step S603, the abnormality determination unit 312 determines whether or not an amount of lateral (left or right) deviation of the vehicle 10 is equal to or greater than a predetermined amount. In this step S603, it is determined whether or not the vehicle 10 has performed an S-shaped travel. If, after registration is made as a PH candidate position, the wheel acceleration is no longer equal to or greater than the predetermined acceleration and the amount of lateral deviation is equal to or greater than the predetermined amount, it is considered that the vehicle 10 is avoiding the PH by performing an S-shaped travel. When an affirmative determination is made in step S603, the processing proceeds to step S604, whereas when a negative determination is made, the processing proceeds to step S605.

In step S604, the abnormality determination unit 312 determines that a PH is present at the PH candidate position. In other words, the behavior of the vehicle 10 has changed between the past (first time) and the present (second time), and the vehicle 10 is exhibiting the behavior of avoiding a PH, so it is determined that a PH is present. On the other hand, in step S605, the abnormality determination unit 312 determines that there is no PH at the PH candidate position. In other words, if the vehicle 10 does not perform an S-shaped travel when passing through the road again after the wheel acceleration becomes equal to or greater than the predetermined acceleration, the user is most likely not aware of the PH. In this case, it is considered that a PH is not present. Therefore, the abnormality determination unit 312 determines that there is no PH at this location. Then, in step S606, the abnormality determination unit 312 resets the PH candidate position by deleting the information stored as the PH candidate position for this location.

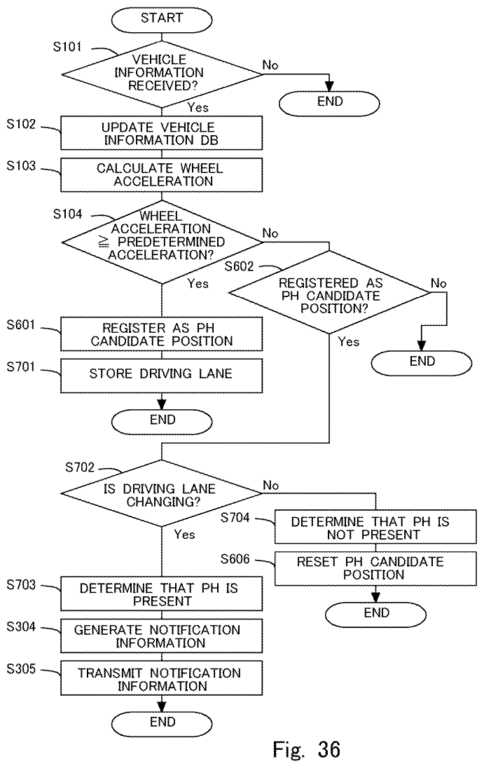

In addition, FIG. 36 is a flowchart of processing for determining whether or not a PH is present, based on driving lanes according to the fifth embodiment. A routine illustrated in FIG. 36 is executed at predetermined time intervals at the server 30. Here, note that the steps in which the same processing is performed as in the flowcharts described above are denoted by the same reference signs, and the description thereof will be omitted. In the routine illustrated in FIG. 36, when an affirmative determination is made in step S104, then in step S601, the abnormality extraction unit 311 registers the position of the vehicle 10 as a PH candidate position, and in step S701, the abnormality extraction unit 311 stores the driving lane at the time when the vehicle 10 entered the analysis range including the PH candidate position in the auxiliary storage unit 303. This driving lane is a lane in which a PH may be present.

On the other hand, when an affirmative determination is made in step S602, then in step S702, the abnormality determination unit 312 compares the driving lane stored in step S702 with the current driving lane to determine whether or not there is a change. That is, it is determined whether or not the driver remembers the position of the PH and has changed the driving lane in advance. The current driving lane is read from the vehicle information DB 321 updated in step S102. When an affirmative determination is made in step S702, the processing proceeds to step S703, whereas when a negative determination is made, the processing proceeds to step S704.

In step S703, the abnormality determination unit 312 determines that a PH is present at the PH candidate position. On the other hand, in step S704, the abnormality determination unit 312 determines that there is no PH at the PH candidate position. That is, when the vehicle 10 passes through the road again, after the wheel acceleration becomes equal to or greater than the predetermined acceleration, the wheel acceleration becomes less than the predetermined acceleration even though the driving lane of the vehicle 10 has not changed, as a result of which it is considered that when the PH candidate position was stored, the wheel acceleration became equal to or greater than the predetermined acceleration due to factors other than the PH. Therefore, the abnormality determination unit 312 determines that there is no PH at this location.

Here, note that if it is determined whether or not a PH is present based on only the result of one vehicle 10, there is a possibility that an erroneous determination may occur due to the influence of factors other than the PH. Therefore, for example, in cases where it is determined that the PH is present in a plurality of vehicles 10, the notification unit 313 may generate notification information. In this case, the processing of step S304 and step S305 in FIGS. 34 and 35 is not performed. Then, the following processing is executed.

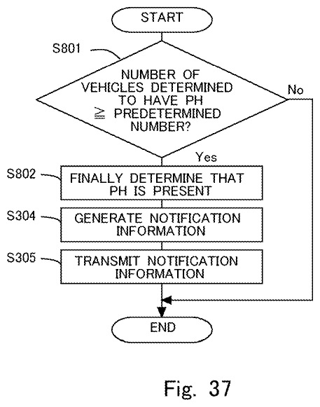

FIG. 37 is a flowchart of processing for notifying the presence of a PH based on data of a plurality of vehicles 10. A routine illustrated in FIG. 37 is executed at predetermined time intervals at the server 30. In step S801, the notification unit 313 determines whether or not the number of vehicles 10 in which a PH has been determined to be present is equal to or greater than a predetermined number. The predetermined number has been stored in the auxiliary storage unit 303 as the number of vehicles 10 required to accurately detect a PH. In this step S801, it is determined whether or not the number of vehicles 10 in which a PH was determined to be present in step S604 or step S703 is sufficiently large. When an affirmative determination is made in step S801, the processing or routine proceeds to step S802, whereas when a negative determination is made, this routine is ended. When a negative determination is made, no notification is made to the user terminal 20.

In step S802, the notification unit 313 finally determines that a PH is present. That is, since a PH has been determined to be present in the plurality of vehicles 10, it is finally determined that a PH is present at that position, and notification information is transmitted to the user terminal 20 by the processing in step S304 onward.

As described above, according to the fifth embodiment, it is possible to determine whether or not a PH is present based on a change in behavior at the time when the same vehicle 10 passes through the same road.

### OTHER EMBODIMENTS

The above-described embodiments are merely examples, but the present disclosure can be implemented with appropriate modifications without departing from the spirit thereof.

The processing and/or means (devices, units, etc.) described in the present disclosure can be freely combined and implemented as long as no technical contradiction occurs.

In addition, the processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner. For example, the vehicle 10 or the user terminal 20 may have some or all of the functions of the server 30.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus comprising a controller configured to determine, in response to obtaining first information about a possibility of an abnormality in a road, the abnormality in the road based on behaviors of a plurality of vehicles in a predetermined range including a position corresponding to the first information.

2. The information processing apparatus according to claim 1, wherein
the controller obtains the first information based on output values of sensors that are provided in the plurality of vehicles, respectively, and that output signals related to conditions of the road; and
the controller further determines whether or not there is the abnormality in the road, based on a number of vehicles that output information about a first behavior, which is a behavior at the time of avoiding the abnormality in the road, in the predetermined range.

3. The information processing apparatus according to claim 2, wherein
the controller determines whether there is the abnormality in the road, based on a proportion of vehicles that output information about the first behavior among vehicles that output the first information and a proportion of vehicles that output information about the first behavior among vehicles that did not output the first information, in the predetermined range.

4. The information processing apparatus according to claim 2, wherein
the controller determines that there is the abnormality in the road, in response to the fact that a proportion of vehicles that output information about the first behavior among vehicles that did not output the first information is higher than a proportion of vehicles that output information about the first behavior among vehicles that output the first information, in the predetermined range.

5. The information processing apparatus according to claim 2, wherein
the first behavior includes that the vehicles have moved more than a predetermined distance to the right and to the left, respectively.

6. The information processing apparatus according to claim 1, wherein
the controller determines whether or not there is the abnormality in the road, based on traveling positions of the plurality of vehicles in a first period in the past and traveling positions of the plurality of vehicles in a second period that is later than the first period, in the predetermined range.

7. The information processing apparatus according to claim 6, wherein
the controller determines that there is the abnormality in the road, in response to the fact that there is a predetermined difference between the traveling positions of the plurality of vehicles in the first period and the traveling positions of the plurality of vehicles in the second period, in the predetermined range.

8. The information processing apparatus according to claim 1, wherein
the controller determines whether or not there is the abnormality in the road, based on a change in behavior of a same vehicle at the time when the same vehicle travels in the predetermined range in a first time in the past and in a second time later than the first time.

9. The information processing apparatus according to claim 8, wherein
the controller obtains the first information based on output values of sensors that are provided in the plurality of vehicles, respectively, and that output signals related to conditions of the road; and
in cases where the same vehicle travels in the predetermined range in the first time and in the second time, the controller determines that there is the abnormality in the road, in response to the fact that in the first time, the first information is output and information about the first behavior, which is a behavior to avoid the abnormality in the road, is not output, and in the second time, the first information is not output and the information about the first behavior is output.

10. The information processing apparatus according to claim 1, wherein
the controller obtains the behaviors of the plurality of vehicles in the predetermined range by obtaining detected values of sensors that are related to a direction of travel and that are provided in the plurality of vehicles, respectively.

11. The information processing apparatus according to claim 1, wherein
when determining that there is the abnormality in the road, the controller notifies an external terminal of a position at which the abnormality is present.

12. The information processing apparatus according to claim 1, further comprising a memory configured to store data about the behaviors of the plurality of vehicles that have traveled in the predetermined range.

13. The information processing apparatus according to claim 1, wherein the controller determines whether or not there is the abnormality in the road, after a predetermined period of time has elapsed since an inspection is performed by a user.

14. An information processing method comprising:
determining, by a computer, in response to obtaining first information about a possibility of an abnormality in a road, the abnormality in the road based on behaviors of a plurality of vehicles in a predetermined range including a position corresponding to the first information.

15. The information processing method according to claim 14, further comprising:
obtaining, by the computer, the first information based on output values of sensors that are provided in the plurality of vehicles, respectively, and that output signals related to conditions of the road; and
determining, by the computer, whether or not there is the abnormality in the road, based on a number of vehicles that output information about a first behavior, which is a behavior at the time of avoiding the abnormality in the road, in the predetermined range.

16. The information processing method according to claim 15, further comprising:
determining, by the computer, whether there is the abnormality in the road, based on a proportion of vehicles that output information about the first behavior among vehicles that output the first information and a proportion of vehicles that output information about the first behavior among vehicles that did not output the first information, in the predetermined range.

17. The information processing method according to claim 15, further comprising:
determining, by the computer, that there is the abnormality in the road, in response to the fact that a proportion of vehicles that output information about the first behavior among vehicles that did not output the first information is higher than a proportion of vehicles that output information about the first behavior among vehicles that output the first information, in the predetermined range.

18. The information processing method according to claim 14, further comprising:
determining, by the computer, whether or not there is the abnormality in the road, based on traveling positions of the plurality of vehicles in a first period in the past and traveling positions of the plurality of vehicles in a second period that is later than the first period, in the predetermined range.

19. The information processing method according to claim 18, further comprising:
determining, by the computer, that there is the abnormality in the road, in response to the fact that there is a predetermined difference between the traveling positions of the plurality of vehicles in the first period and the traveling positions of the plurality of vehicles in the second period, in the predetermined range.

20. The information processing method according to claim 14, further comprising:
determining, by the computer, whether or not there is the abnormality in the road, based on a change in behavior of a same vehicle at the time when the same vehicle travels in the predetermined range in a first time in the past and in a second time later than the first time.
